(19) United States
(12) Patent Application Publication
(10) Pub. No.: US 2007/0119146 A1
(43) Pub. Date: May 31, 2007

(54) Retarding and filter cleaning method and system

(75) Inventors: James J. Callas, Peoria, IL (US); Kevin L. Martin, Washburn, IL (US); Cody P. Renshaw, Peoria, IL (US); Thomas M. Sopko, East Peoria, IL (US); Andrew J. Tonsor, East Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/289,321

(22) Filed: Nov. 30, 2005

(51) Int. Cl. F02C 7/052

(52) U.S. Cl. 60/39.092

(57) ABSTRACT

A filter cleaning system is provided for a gas turbine engine including a compressor section and a combustor section. A mechanism is operatively connected to the gas turbine engine and is configured to be driven by the gas turbine engine in a first mode and configured to drive the gas turbine engine in a second mode. A first flow path is for delivering compressed air to the compressor section. At least one air filter is configured to filter air entering the first flow path. A second flow path is for delivering compressed air from the compressor section to the combustor section in the first mode. A third flow path is for delivering compressed air from the compressor section to the at least one air filter during the second mode.

### TECHNICAL FIELD

The present disclosure relates generally to a retarding and filter cleaning method and system and, more particularly, to a work machine having a gas turbine engine and employing a retarding and filter cleaning method and system.

### BACKGROUND

Work machines such as, for example, on-highway and off-road haulage vehicles, wheeled tractors, track type tractors, and various construction work machines, may receive motive power from any one of a number of different types of engines. For example, a work machine may be powered by a gasoline engine, a diesel engine, or a gas turbine engine. Work machines powered by a gas turbine engine may use the gas turbine engine to drive a mechanism that may be used to transfer the engine power output into work machine propulsion or other work machine operations.

Work machines may require various retarders to aid braking. When descending slopes, for example, work machines may use retarding systems in order to dissipate kinetic energy so as to maintain a safe speed. For example, heavy work machines may use the momentum of the machine when moving down a slope to drive the engine. The engine, in the case of a piston engine such as, for example, a diesel engine, then operates as a compressor, dissipates kinetic energy, and retards the motion of the work machine.

Work machines may operate in environments characterized by dirt particles, dust, mud, rock particles, and other substances that may be detrimental to engine operation. The nature of a gas turbine engine dictates that it uses a large quantity of air. For example, a gas turbine engine may require as much as four time the air flow of a diesel engine comparable in power. Suitable filtering structure may be provided for precluding contaminants from reaching and damaging the engine. For example, in a work machine powered by a gas turbine engine, the intake air flow for the engine may be provided with one or more filters to ensure that the rather large flow of air directed to the gas turbine engine is reasonably free from contaminants that may harm the engine components.

Because of the rather large flow of air required by a gas turbine engine, and because the engine may operate in dusty, dirty conditions, air filters for gas turbine engines may require frequent cleaning or replacement. Frequent cleaning or replacement may require frequent down-time periods for the gas turbine engine and for the work machine.

It would be useful to provide a system, structure, and method whereby air filters for a gas turbine engine may be efficiently and effectively cleaned. Additionally, it would be useful if provision could be made for cleaning air filters for a gas turbine engine with only limited compromising of space constraints. Moreover, it would be particularly helpful if cleaning of the air filters could be accomplished effectively as a by-product of another work machine operation, such as work machine retarding, without experiencing work machine down time.

One method of cleaning an air filter for a gas turbine engine is described in U.S. Pat. No. 5,401,285 (the '285 patent) issued to Gillingham, et al. on Mar. 28, 1995. The '285 patent describes an air filter system that may be used in the gas turbine engine powered M1 tank. The '285 patent provides a pulse jet arrangement to direct air backward through the filter to regenerate it periodically between times of filter replacement. A compressed air tank is provided as a supply of compressed air for the pulse jets. The compressed air tank is supplied with compressed air by a bleed conduit from the turbine.

Although the method described in the '285 patent may recognize the need for frequent cleaning of air filters for a gas turbine engine, the '285 patent employs a separate system to do so. Rather than using an existing operation to directly facilitate filter cleaning, the '285 patent requires a system of compressed air tanks and “pulse jets,” as well as the space necessary for these components. Moreover, there is no recognition in the '285 patent that filter cleaning may be accomplished in association with a retarding function.

The disclosed retarding and filter cleaning method is directed to overcoming one or more of the problems outlined above with respect to existing technology.

### SUMMARY OF THE INVENTION

In one aspect, the present disclosure includes a filter cleaning system for a gas turbine engine. The gas turbine engine includes a compressor section and a combustor section. A mechanism is operatively connected to the gas turbine engine and is configured to be driven by the gas turbine engine in a first mode and configured to drive the gas turbine engine in a second mode. A first flow path is provided for delivering air to the compressor section. At least one air filter is in the first flow path for filtering the air to be delivered to the compressor section. A second flow path is provided for delivering compressed air from the compressor section to the combustor section during the first mode. A third flow path is provided for delivering compressed air from the compressor section to the at least one air filter during the second mode.

In another aspect, the present disclosure includes a method of cleaning a filter for a gas turbine engine. In a first mode, a gas turbine engine including a compressor section and a combustor section drives a mechanism. Air is passed through at least one air filter and delivered to the compressor section. During the first mode, compressed air from the compressor section is delivered to the combustor section. During a second mode, the compressor section is driven by the mechanism. During the second mode, compressed air from the compressor section is delivered to clean the at least one air filter.

It is to be understood that both the foregoing general description and the following detailed description are exemplary and explanatory only and are not restrictive of the claims.

### BRIEF DESCRIPTION OF THE DRAWINGS

FIG. 1 is a highly diagrammatic and schematic illustration of an embodiment of a work machine powered by a gas turbine engine and having a filtering system;

FIG. 2 is a diagram of an embodiment of a gas turbine engine and filtering system shown in a mode for cleaning a first filter; and

FIG. 3 is a diagram similar to FIG. 2 and showing an embodiment of a gas turbine engine and filtering system in a mode for cleaning a second filter.

### DETAILED DESCRIPTION

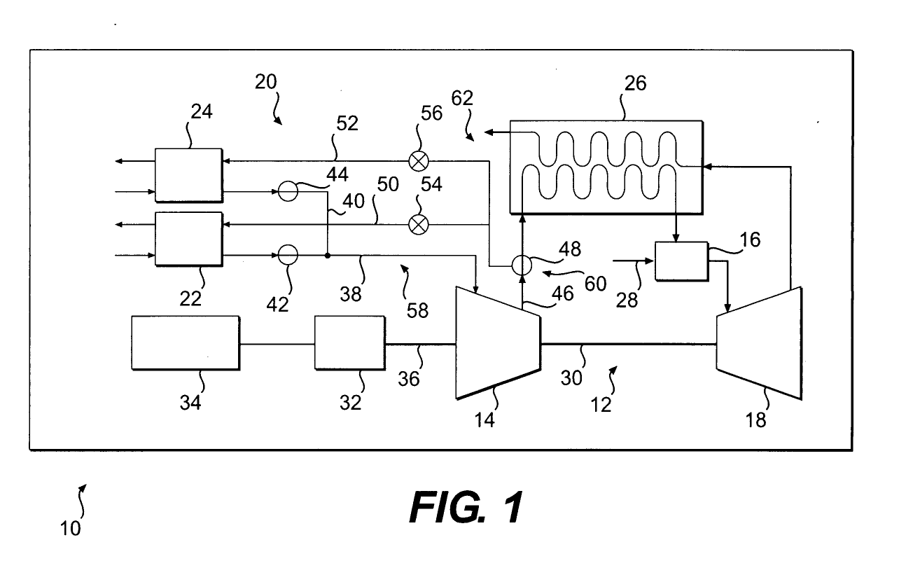

FIG. 1 diagrammatically illustrates an exemplary work machine 10. Work machine 10 includes a chassis (generally designated by the rectangular outline) and may be, for example, a track-type tractor, a track-type loader, a hydraulic excavator, a mining truck, a wheel loader, an off-road haulage vehicle, an on-highway truck, or another work machine known to those skilled in the art. The particular type of work machine involved is generally incidental to the system disclosed. Those having skill in the art will readily be able to apply the disclosed system and method to various types of work machines once apprised of the embodiments disclosed herein. Work machine 10 may include a gas turbine engine 12 as its prime mover. Gas turbine engine 12 may include a compressor section 14 configured to draw in a relatively large amount of intake air during operation and configured to compress the air drawn in. Gas turbine engine 12 may also include a combustor section 16 and a turbine section 18.

Work machine 10 may include an air flow system generally indicated at 20. Air flow system 20 may include various conduits and valves, the arrangement and purpose of which will be explained in due course. Air flow system 20 may also include one or more air filters 22, 24 configured to substantially reduce the amount of dust, dirt particles, rocks, and various other contaminants drawn into gas turbine engine 12. It will be understood that the work machine may include only a single air filter, or it may include a plurality of air filters. To illustrate the disclosed system and method with reasonable simplicity, two filters are shown in FIGS. 1-3.

Gas turbine engine 12 may include a recuperator 26 configured to heat compressed air received from compressor section 14. The recuperator 26 may derive heat from turbine section 18 exhaust as the exhaust passes through the recuperator 26 on its way to the atmosphere. Combustor section 16 may be configured to receive heated, compressed air from the recuperator 26. The combustor section 16 may be provided with fuel from, for example, a fuel injection device schematically shown at 28. Ignition and burning of the heated, compressed air and fuel creates an exhaust gas with high energy. Turbine section 18 of gas turbine engine 12 is configured to convert energy from the exhaust gas into mechanical energy when the exhaust gas passes through turbine section 18. Turbine section 18 is operably coupled to a power shaft 30 configured to be rotated by turbine section 18.

Work machine 10 may further include a mechanism 32 operably coupled to power shaft 30. A drive connection, such as shaft 36 between compressor section 14 and mechanism 32, for example, may couple power shaft 30 to mechanism 32. Mechanism 32 is diagrammatically shown in FIGS. 1-3 since the particular mechanism to be driven by gas turbine engine 12 may vary with the type of work machine and with the type of drive system employed on a given type of work machine. Mechanism 32 may be mechanical, hydraulic, electrical, or any other mechanism useful to convert the output of gas turbine engine 12 to propulsion for a work machine.

Mechanism 32 may be, for example, the lower power train of a work machine, including gearing mechanically coupled to wheels (not shown) and/or ground engaging tracks (not shown). Mechanism 32 may alternatively be a generator configured to convert mechanical energy developed by gas turbine engine 12 into electric energy for use as a power source to power, for example, one or more electric motors, such as electric motor 34, shown in FIG. 1, configured to propel work machine 10. Mechanism 32 may be configured to deliver power back to and drive gas turbine engine 12 to retard work machine 10 when work machine 10 is descending a slope, for example.

The various conduits and valves of air intake system 20 are illustrated in FIGS. 1-3. The illustrated valving is designed to permit flow or air between filters 22, 24 and compressor section 14 in opposite directions. It will be understood that the simplified arrangement of conduits and valves shown in FIGS. 1-3 is for purposes of illustration only. It will be apparent to those having skill in the art that, once the disclosed embodiment has been revealed, other suitable expedients for permitting the flow of air in opposite directions, in the manner to be shortly explained, will become apparent.

A conduit 38 may enable the flow of air between air filter 22 and compressor section 14 while a conduit 40 may extend between air filter 24 and a suitable connection to conduit 38 to enable the flow of air from air filter 24 to compressor section 14. Valve 42 may be positioned in conduit 38 between air filter 22 and the location where conduit 40 connects to conduit 38. Valve 44 may be positioned in conduit 40. Valves 42 and 44 may be selectively controlled to permit the flow of air from a respective air filter 22, 24 in a first position of the valve, or to preclude the flow of air from a respective air filter 22, 24 in a second position of the valve.

A conduit 46 may enable the flow of compressed air from compressor section 14 into recuperator 26. Valve 48 may be mounted in conduit 46. Conduit 50 may extend between valve 48 and air filter 22 and enable flow of air from compressor section 14 to air filter 22. Conduit 52 may extend from conduit 50 to air filter 24 and enable flow of compressed air from compressor section 14 to air filter 24. Valve 54 may be situated in conduit 50 at a location between valve 48 and air filter 22. Conduit 52 may connect to conduit 50 at a location between valve 54 and valve 48. Valve 56 may be situated in conduit 52.

Valve 48 may be selectively controlled to permit the flow of compressed air along conduit 46 to recuperator 26, while precluding the flow of compressed air into conduit 50 or conduit 52. Valve 48 may also be selectively controlled to permit the flow of compressed air into conduit 50 while precluding the flow of compressed air into recuperator 26. Valves 54 and 56 may be selectively controlled to permit the flow of compressed air from compressor section 14 to a respective air filter 22, 24 in a first position of the valve, or to preclude the flow of compressed air from compressor section 14 to a respective air filter 22, 24 in a second position of the valve.

Air flow system 20 may be characterized as embodying different flow paths. For example, conduits 38 and 40, leading from air filters 22, 24 to compressor section 14 may be characterized as a first flow path 58 for delivering filtered air to compressor section 14. Conduit 46 may be characterized as a second flow path 60 for delivering compressed air from compressor section 14 to combustor 14. FIGS. 1-3 diagrammatically show the connection of conduit 46 to recuperator 26 and the flow line in recuperator 26 ultimately leading to combustor section 16. Conduit 50 leading from valve 48 to air filter 22 along with conduit 52 and the portion of conduit 46 between compressor section 14 and valve 48 may be characterized as a third flow path 62.

It will be apparent that second flow path 60 is at least partly coextensive with third flow path 62. It will also be apparent that first flow path 58 includes two branches, one of which, in the exemplary embodiment, is conduit 40 leading from air filter 24, and the other of which is the portion of conduit 38 leading from air filter 22 up to the location where conduit 40 connects to conduit 38. Further, it will be apparent that third flow path 62 includes two branches, one of which, in the exemplary embodiment, is conduit 52 leading to air filter 24, and the other of which is the portion of conduit 50 leading from the location where conduit 52 connects to conduit 50 up to air filter 22.

### INDUSTRIAL APPLICABILITY

In the exemplary work machine 10 schematically depicted in FIG. 1, gas turbine engine 12 provides mechanical power for work machine 10. Compressor section 14 draws in and compresses a relatively large amount of intake air, which may be filtered by one or more air filters 22, 24 to substantially prevent dust, dirt particles, rocks, and other contaminants from being drawn into compressor section 14.

Once compressed in compressor section 14, compressed air enters recuperator 26, where the compressed air may be heated by hot gases exhausted from turbine section 18. Following heating, the compressed air may be fed into combustor section 16, which may receive fuel from fuel injection device 28. Combustor section 16 ignites the compressed air and fuel, thereby creating a heated, high energy exhaust gas.

The heated exhaust gas may be passed through turbine section 18, which converts energy in the heated exhaust gas into mechanical energy as the heated exhaust gases pass through turbine section 18. Once it passes through turbine section 18, the exhaust gas may be fed into recuperator 26 to heat compressed air entering recuperator 26 from compressor section 14. The exhaust gases may thereafter be exhausted to the atmosphere.

Turbine section 18 may be operably coupled to power shaft 30, for example, via direct connection, such that when turbine section 18 rotates in response to the flow of the heated exhaust gas, power shaft 30 is also rotated. Power shaft 30 is operably coupled to compressor section 14 so that compressor section 14 may continue to compress air drawn in through, for example, air filter 22 and/or air filter 24. In addition to being operably coupled to compressor section 14, power shaft 30 may be operably coupled to mechanism 32 through, for example, shaft 36.

Mechanism 32 converts the energy output of gas turbine engine 12 into propulsion for work machine 10. In the embodiment of FIG. 1, for example, mechanism 32 may be a generator which converts mechanical energy developed by gas turbine engine 12 into electric energy for use as a power source to power, for example, one or more electric motors 34 configured to propel work machine 10, for example, via ground engaging members such as wheels and/or a pair of ground engaging tracks. The mode of operation in which compressor section 14 delivers compressed air to combustor section 16 and in which gas turbine engine 12 drives mechanism 32 may conveniently be referred to as a first mode of operation.

Work machine 10 may be provided with a retarding system to supplement a braking system. For example, during downhill motion of the work machine, energy from the work machine is directed back through mechanism 32 to drive the gas turbine engine. For example, referring to FIG. 1, the one or more electric motors 34 may, during downhill motion of the work machine, be configured to act as generators providing electric current to the generator 32 which, in turn, may be configured to act as a motor. Thus, generator 32 may be converted to a “motoring” mode in which it may drive compressor section 14 of gas turbine engine 12. This mode of operation wherein the gas turbine engine is driven by way of mechanism 32 may conveniently be referred to as a second mode of operation. During this second mode of operation, fuel injection device 28 may be substantially inhibited from supplying fuel to combustor 16. In this way, instead of being driven by turbine section 18 and combustor section 16, compressor section 14 of gas turbine engine 12 is driven by the mechanism 32.

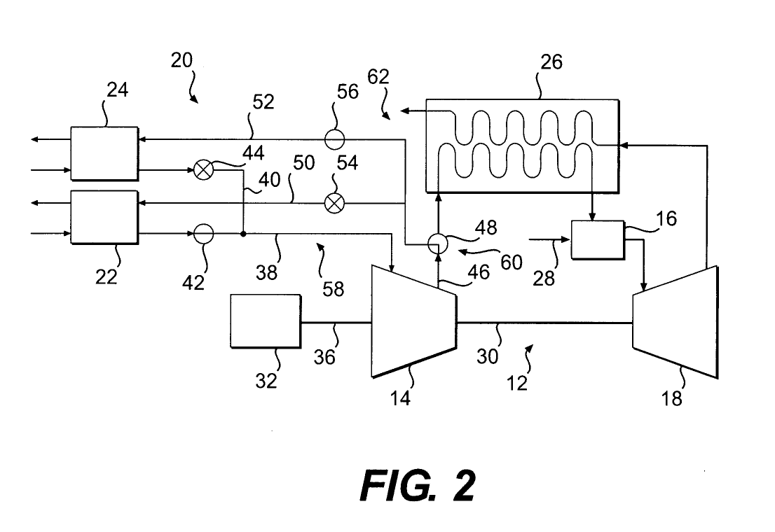

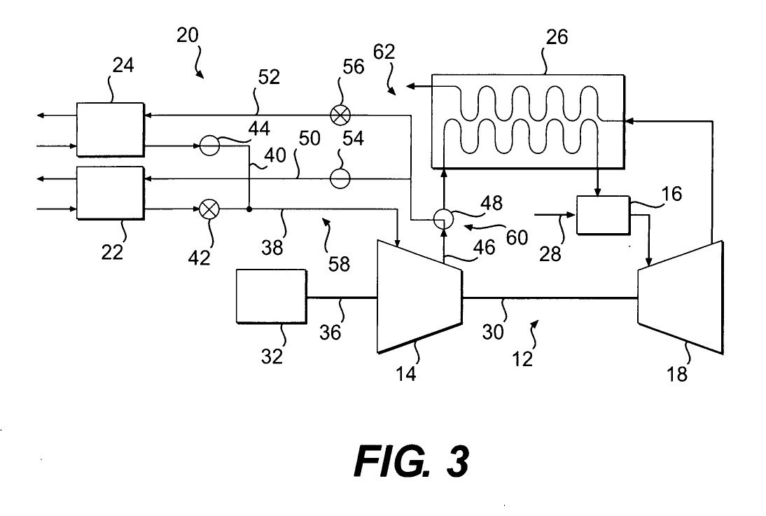

The second mode of operation is illustrated in FIGS. 2 and 3. During this second mode of operation, the work machine motion is being retarded since energy of work machine motion is being dissipated through the driving of compressor section 14 and connected turbine section 18. At this time, valve 48 may be positioned to preclude the flow of compressed air along flow path 60 to combustor section 16 and to direct compressed air exiting compressor section 14 along flow path 62. At the same time, one of valves 54 and 56 is open to permit the flow of compressed air while the other of valves 54 and 56 is closed to preclude the flow of compressed air. Also at the same time, one of valves 42 and 44 is open to permit the flow of filtered air to compressor section 14 along flow path 58 while the other of valves 42 and 44 is closed to preclude the flow of filtered air to compressor section 14.

Filtered air may be supplied to compressor section 14 and compressed air may be delivered to at least one of the filters to clean the filter during the second, retarding mode. In order to permit both flow of filtered air to compressor section 14 and flow of compressed air to at least one of the air filters 22, 24, valves 42, 44, 54, and 56 may be coordinated in operation. FIG. 2 is an embodiment illustrating the situation where air filter 24 is being cleaned during the retarding mode while filtered air is being provided to compressor section 14 by way of air filter 22. In this situation, valve 56 is in an open position while valve 54 is closed. In a similar manner, valve 42 is in an open position while valve 44 is closed. FIG. 3 is an embodiment illustrating the situation where air filter 22 is being cleaned during the second, retarding mode while filtered air is being provided to compressor section 14 by way of air filter 24. In this situation, valve 54 is in an open position while valve 56 is closed. In a similar manner, valve 44 is in an open position while valve 42 is closed.

It can readily be seen that the disclosed embodiments provide for the more frequent cleaning of air filters that may be necessary with the use of a gas turbine engine, particularly during operation in an environment that produces substantial dust, dirt, and other contaminants that may be harmful to the engine. Instead of an entirely separate system for cleaning the filters, such as filters 22, 24, advantage is taken of an engine and work machine retarding function. Where the engine is not used to drive the mechanism 32 and provide power to the work machine, the work machine may be permitted to dissipate energy through driving mechanism 32. Where mechanism 32 is a generator, “motoring” the generator may drive the compressor section 14 of gas turbine engine 12 and simultaneously clean one or more of air filters 22, 24 with the compressed air output from compressor section 14.

For purposes of illustration, a particular arrangement of conduits and valves has been shown and described to diagrammatically depict the system and method disclosed. However, it will be understood by those skilled in the art that various arrangements of conduits and valves may be employed to create flow paths for delivering filtered air to the compressor section, for delivering compressed air to the combustor section, and for delivering compressed air to clean the air filters. The disclosure is not to be limited by the particular embodiments diagrammatically illustrated and described herein.

It will be apparent to those skilled in the art that various modifications and variations can be made to the disclosed turbine retarding and filter cleaning method and system. For example, while the system has been disclosed primarily in connection with retarding the motion of a work machine, it will be apparent that the method and system could be employed in a stationary system wherein a gas turbine engine drives a generator which in turn provides electric power. In such a situation, suitable circuitry could be provided by those skilled in the art for periodically driving the generator to drive the compressor section and enable filter cleaning. Other embodiments will be apparent to those skilled in the art from consideration of the specification and practice of the disclosed method and system. It is intended that the specification and examples be considered as exemplary only, with a true scope being indicated by the following claims and their equivalents.

What is claimed is:

1. A filter cleaning system for a gas turbine engine comprising:
a gas turbine engine including a compressor section and a combustor section;
a mechanism operatively connected to the gas turbine engine and configured to be driven by the gas turbine engine in a first mode and configured to drive the gas turbine engine in a second mode;
a first flow path for delivering air to the compressor section;
at least one air filter configured to filter air entering the first flow path;
a second flow path for delivering compressed air from the compressor section to the combustor section during the first mode; and
a third flow path for delivering compressed air from the compressor section to the at least one air filter during the second mode.

2. The system of claim 1, wherein the second flow path is at least partly coextensive with the third flow path.

3. The system of claim 1, wherein the at least one filter includes two filters.

4. The system of claim 3, wherein the third flow path includes two branches, one leading to each of the two filters, and further including a valve located in each of the two branches.

5. The system of claim 4, wherein both valves are closed during the first mode.

6. The system of claim 4, wherein at least one of the valves is open during the second mode.

7. The system of claim 3, wherein the first flow path includes two branches, one leading from each of the two filters, and further including a valve located in each of the two branches.

8. The system of claim 7, wherein both valves are open during the first mode.

9. The system of claim 7, wherein at least one of the valves is closed during the second mode.

10. The system of claim 1, wherein the second and third flow paths connect to form a coextensive portion connected to the compressor section, and further including a valve located where the second and third flow paths connect, the valve configured to selectively permit air flow in the second flow path during the first mode, or permit air flow in the third flow path during the second mode.

11. The system of claim 1, wherein the mechanism is selected from the group consisting of a mechanical mechanism, a hydraulic mechanism, and an electrical mechanism.

12. The system of claim 1 wherein the mechanism includes a generator.

13. A method of cleaning a filter for a gas turbine engine, comprising:
driving a mechanism with a gas turbine engine having a compressor section and a combustor section during a first mode;
passing air through at least one air filter and delivering the filtered air to the compressor section;
delivering compressed air from the compressor section to the combustor section during the first mode;
driving the gas turbine engine with the mechanism in a second mode;
delivering compressed air from the compressor section to clean the at least one air filter in the second mode.

14. The method of claim 13, further including passing air through two air filters and delivering the filtered air to the compressor section.

15. The method of claim 13, further including passing air through one air filter and delivering the filtered air to the compressor section while delivering compressed air from the compressor section to clean a second air filter.

16. The method of claim 15, further including delivering compressed air from the compressor section to the combustor section during the first mode and delivering compressed air from the compressor section to clean the second air filter in the second mode along flow paths that are at least partially coextensive.

17. The method of claim 13, further including providing valves to control the delivering of compressed air to the combustor section and the delivering of compressed air to clean the at least one filter.

18. The method of claim 13, wherein driving a mechanism includes driving a mechanism selected from the group consisting of a mechanical mechanism, a hydraulic mechanism, and an electrical mechanism, and driving the gas turbine engine with the mechanism includes driving the gas turbine engine with the mechanism selected from the group consisting of a mechanical mechanism, a hydraulic mechanism, and an electrical mechanism.

19. The method of claim 13, wherein driving a mechanism includes driving a generator, and driving the gas turbine engine with the mechanism includes driving the gas turbine engine with the generator.

20. A work machine, comprising:
a chassis;
a gas turbine engine mounted to the chassis and having a compressor section and a combustor section;
a first flow path for delivering air to the compressor section;
at least one air filter in the flow path for filtering air delivered to the compressor section;
a second flow path for delivering compressed air from the compressor section to the combustor section in a first mode;
a third flow path for delivering compressed air from the compressor section to clean the at least one air filter in a second mode; and
a mechanism configured to be driven by the gas turbine engine in the first mode and to drive the gas turbine engine in the second mode to deliver the compressed air to clean the at least one air filter.

21. The work machine of claim 20, wherein the second flow path includes a portion that is coextensive with a portion of the third flow path, and further including a valve configured to control the delivering of compressed air in the first and second modes.

22. The work machine of claim 20, wherein the at least one air filter includes a plurality of air filters, and further including a plurality of valves configured to permit the delivering of compressed air through at least one of the plurality of air filters to the compressor section while permitting delivering of compressed air from the compressor section to clean at least another of the plurality of air filters.

23. The work machine of claim 20, wherein the mechanism is selected from the group consisting of a mechanical mechanism, a hydraulic mechanism, and an electrical mechanism

24. The work machine of claim 20, wherein the mechanism includes a generator.

25. A method of retarding a work machine having a gas turbine engine and cleaning an air filter for the gas turbine engine, comprising:
driving a mechanism with the gas turbine engine during a first mode of operation, the gas turbine engine having a compressor section and a combustor section;
dissipating energy and retarding the work machine by driving the compressor section with the mechanism during a second mode of operation;
passing air through at least one air filter and delivering the filtered air to the compressor section during the first mode of operation; and
delivering compressed air from the compressor section to clean the at least one air filter during the second mode of operation.

26. The method of claim 25, wherein driving a mechanism includes driving a mechanism selected from the group consisting of a mechanical mechanism, a hydraulic mechanism, and an electrical mechanism, and wherein dissipating energy and retarding the work machine includes driving the compressor section with the mechanism selected from the group consisting of a mechanical mechanism, a hydraulic mechanism, and an electrical mechanism.

27. The method of claim 25, wherein driving a mechanism includes driving a generator, and dissipating energy and retarding the work machine includes driving the compressor section with the generator.

28. A method of operating a work machine comprising:
delivering energy to a mechanism by a gas turbine engine having a compressor section and a combustor section during a first mode;
passing air in a first direction through at least one air filter to the compressor section during the first mode;
delivering energy from the mechanism to the compressor section during a second, retarding mode; and
delivering air from the compressor section in a second direction through the at least one air filter during the second, retarding mode.

29. The method of claim 28, wherein delivering energy to a mechanism includes delivering energy to a mechanism selected from the group consisting of a mechanical mechanism, a hydraulic mechanism, and an electrical mechanism, and delivering energy from the mechanism includes delivering energy from the mechanism selected from the group consisting of a mechanical mechanism, a hydraulic mechanism, and an electrical mechanism.

30. The method of claim 28, wherein delivering energy to a mechanism includes delivering energy to a generator, and delivering energy from the mechanism includes delivering energy from the generator.

31. A method for retarding a work machine comprising:
providing a work machine with a gas turbine engine;
driving a mechanism with the gas turbine engine during a first mode of work machine operation, the gas turbine engine having a compressor section and a combustor section;
directing air in a forward direction through at least one air filter to the compressor section during the first mode;
retarding the work machine during a second mode of work machine operation by driving the compressor section of the gas turbine engine with the mechanism; and
delivering compressed air from the compressor section in a backward direction through the at least one air filter to clean the at least one air filter in the second mode.

32. The method of claim 31, wherein driving a mechanism include driving a mechanism selected from the group consisting of a mechanical mechanism, a hydraulic mechanism, and an electrical mechanism, and driving the compressor section of the gas turbine engine with the mechanism includes driving the compressor section of the gas turbine engine with the mechanism selected from the group consisting of a mechanical mechanism, a hydraulic mechanism, and an electrical mechanism.

33. The method of claim 31, wherein driving a mechanism includes driving a generator, and driving the compressor section of the gas turbine engine with the mechanism includes driving the compressor section of the gas turbine engine with the generator.

34. A system for retarding a work machine comprising:
a gas turbine engine having a compressor section and a combustor section mounted on the work machine and configured to drive a mechanism;
at least one air filter configured to receive air in a first direction;
a flow path configured to deliver filtered air from the at least one air filter to the compressor section of the gas turbine engine;
a mechanism mounted on the work machine and configured to be driven by the gas turbine engine in a first mode and to drive the compressor section of the gas turbine engine in a second, work machine retarding mode; and
means for delivering compressed air from the compressor section and through the at least one air filter in a second direction to clean the at least one air filter during the second, work machine retarding mode.

35. The system of claim 34, wherein the mechanism is selected from the group consisting of a mechanical mechanism, a hydraulic mechanism, and an electrical mechanism.

36. The system of claim 34, wherein the mechanism is a generator.
